(19) United States
(12) Patent Application Publication
(10) Pub. No.: US 2004/0243035 A1
(43) Pub. Date: Dec. 2, 2004

(54) Tubular dual pressure point massage apparatus

(76) Inventor: Jenny Devlin, Orlando, FL (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/899,829

(22) Filed: Jul. 26, 2004

(51) Int. Cl. A61H 15/00

(52) U.S. Cl. 601/131; 601/128

(57) ABSTRACT

A tubular sleeve is made of a tufted fabric having a pile on an interior surface. A pair of spaced-apart tennis balls each has a diameter exceeding a diameter of the tubular sleeve so that the sleeve engages the balls. The balls are manually positioned within the tubular sleeve. Each of the tennis balls has a fuzzy napped exterior surface. A pair of handles are attached at opposing ends of the tubular sleeve. The pile of the sleeve and the napped surface of the tennis balls are of such substance as to naturally engage in holding the tennis balls in selected engagement positions within the tubular sleeve, yet the balls are able to be manually moved to alternate engagement positions within the sleeve, without purposeful disengagement of the balls and the sleeve.

### BACKGROUND OF THE INVENTION

### RELATED APPLICATIONS

none

### INCORPORATION BY REFERENCE

Applicant(s) hereby incorporate herein by reference, any and all U.S. patents and U.S. patent applications cited or referred to in this application.

1. Field of the Invention

This invention relates generally to massage therapy devices and apparatus, and more particularly to a hand held tubular sleeve with dual balls positionable therewithin for applying a pressure massage to specific areas of ones back and especially to both sides of the spine.

2. Description of Related Art

The following art defines the present state of this field:

Chu, U.S. Pat. No. 4,936,294: A massage device having a substantially planar support of foamed plastic and a plurality of massaging elements in the form of halves of balls distributed uniformly about the support is disclosed. The massaging elements may be substantially the size and firmness of tennis balls and are secured to the support in closely-spaced parallel rows by sleeves in which the massaging elements are arranged end-to-end. The sleeves are gathered between adjacent massaging elements and are secured to the support between adjacent massaging elements.

Suida, U.S. Pat. No. 5,545,456: The present invention relates to an improved wash-cloth having a plurality of pockets for the simultaneous insertion of soap and/or massaging utensils and other medicating items. The pockets can be secured so that any items inserted in the pockets will not be dislocated during use. In addition, the wash-cloth of this invention has gripping handles intergrally knit to the opposing ends of the main body. These handles are held so that wash-cloth can be safely and easily used, particularly by handicapped persons, to effectively clean and massage the back and other difficult to reach areas. One type of massaging utensil is shown and has two apertured balls, which are held together by knotting a length of material that passes through an apertured rod inserted through the aperture of the massaging balls.

Garner et al., U.S. Pat. No. 5,577,996: A hand held massage device having a plurality of spheres adjustably mounted on an axial rod with enlarged grip handles mounted on the outer ends of the rod for rotation. The massage device is easy to use and, because the handles are in axial alignment with the massage spheres, allows the user to apply and direct the desired amount of pressure. The spheres of the massage device may be adjusted to various positions along the axis of the rod to comfort and to direct the massage to specific areas.

Meier, U.S. Pat. No. 5,736,213: An elongated body of generally smooth non-absorbent material with elastic handles on opposite ends thereof. The handles are designed and attached in such a manner to enable one with limited use of the hands to easily hold the device when in use. All the exterior surfaces of the device are nonabrasive and generally soft to prevent irritation of tender or damaged skin. Balls or the like may be included inside the body of the device to provide massaging properties.

Stokes et al, U.S. Pat. No. 5,979,006: The present invention relates to a lotion applicator and massaging apparatus including a pair of opposing substantially U-shaped handles with an attachment plate attached to each of their respective terminal ends. The two opposing attachment plates each have a plurality of cords extending from an opposing side with a snap style connector at their distal ends. A select one of a plurality of accessory pads may be attached to the U-shaped handles depending upon the application. Each applicator pad is substantially rectangular having four peripheral edges and a panel at two opposing edges thereof. Extending from each panel are a plurality of cords with a snap style connector at their distal ends for selectively engaging the snap style connectors on the U-shaped handles. Accordingly, a loofah sponge pad, a dry weave pad or a roller ball massage pad may be selectively attached to the U-shaped handles using the snap style connectors. A heating device is also provided allowing a user to selectively preheat any one of the accessory pads prior to use.

Chen, U.S. Pat. No. 6,174,297: A bath scrubber mainly includes a front nylon piece and a back piece that are sewed up to form a bag defining a unitary inner space for accommodating a plurality of massage balls therein. Restricting means are provided on the back piece and the front nylon piece at positions between any four adjacent massage balls. The restricting means divide the unitary inner space defined by the bag of the bath scrubber into several smaller spaces that each confines a massage ball therein but allows the massage ball to freely and smoothly rotate when the bath scrubber is moved on a user'skin to and fro for cleansing purpose. The bath scrubber with massage balls restricted in separated small spaces can therefore not only hold more bubbles to achieve enhanced cleaning effect but also provide good massage effect.

Mitsunori, JA 11056946A: Problem: To provide a massage unit capable of giving a massage while absorbing the delicate vibration during a travel on a vehicle such as an automobile or an electric car, capable of adjusting the strength of the massage via the adjustment of air, and convenient to carry by inserting tennis balls into an air bag, and utilizing the elasticity of two balls for massaging. Solution: The elasticity of two tennis balls is utilized without using electric energy and power, and a massage can be given while the strength of the massage is freely adjusted via the adjustment of air pressure. A solving means of the conventional technical problem such as energy saving and a technical deployment of the new field are presented.

Our prior art search with abstracts described above teaches: a massage device with planar support, a wash-cloth that cleans and massages, a back massager with dual balls, a lotion applicator and massaging device, a bathing scrubber with massage balls, a lotion applicator and body massage assembly, a bath scrubber with massage balls, and a massage unit utilizing an air bag and tennis balls. Thus, the prior art shows, the balls, and particularly tennis balls are known to be used in massage devices. However, the prior art fails to teach the placement of tennis balls within a sleeve wherein the nap of the balls is engaged by the cloth of the sleeve to fix the balls in designated locations. The present invention fulfills these needs and provides further related advantages as described in the following summary.

### SUMMARY OF THE INVENTION

The present invention teaches certain benefits in construction and use which give rise to the objectives described below.

In a best mode preferred embodiment of the present invention, a tubular sleeve is made of a tufted fabric having a pile on an interior surface. A pair of spaced-apart tennis balls each has a diameter exceeding a diameter of the tubular sleeve so that the sleeve engages the balls. The balls are manually positioned within the tubular sleeve. Each of the tennis balls has a fuzzy napped exterior surface. A pair of handles are attached at opposing ends of the tubular sleeve. The pile of the sleeve and the napped surface of the tennis balls are of such substance as to naturally engage in holding the tennis balls in selected engagement positions within the tubular sleeve, yet the balls are able to be manually moved to alternate engagement positions within the sleeve, without purposeful disengagement of the balls and the sleeve.

A primary objective of one embodiment of the present invention is to provide an apparatus and method of use of such apparatus that yields advantages not taught by the prior art.

Another objective is to provide a massage device capable of being made light in weight yet effective in its massaging power.

A further objective is to provide a massage device particularly suitable for massaging the back lateral to the spine.

A still further objective is to provide a massage device capable of being easily adjusted to apply massage pressure to two points on the body that are a selected distance apart and to easily change the distance.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is an elevational exploded view of the several components of one embodiment of the invention including a cloth shown laid out flat prior to sewing into a tubular sleeve conformation, two C-shaped handles and two tennis balls;

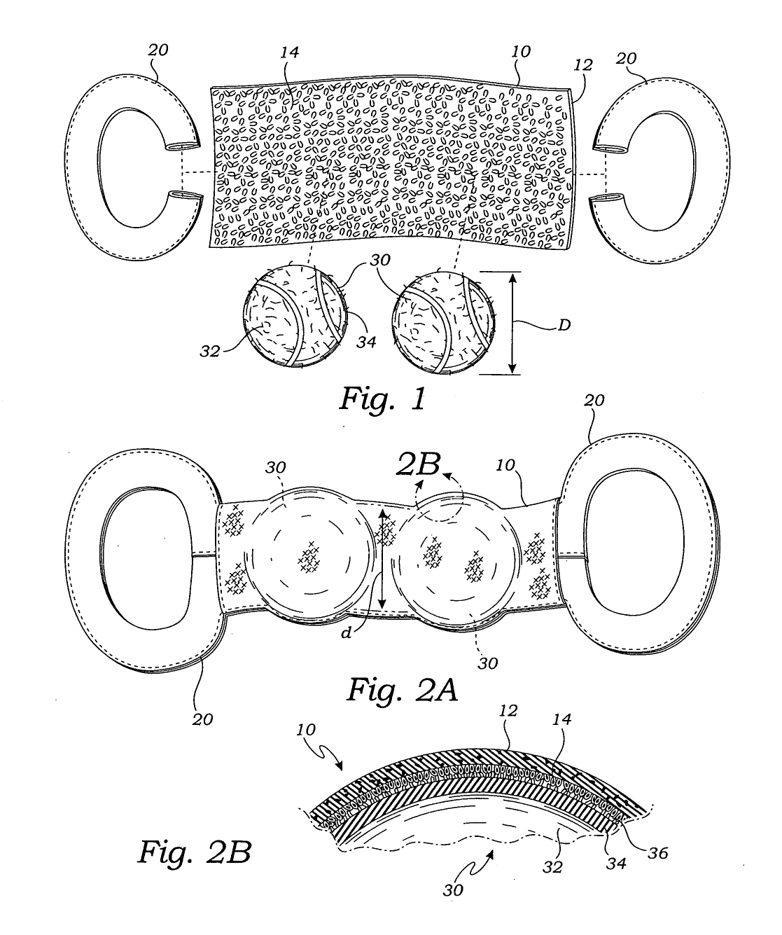

FIG. 2 is a frontal elevational view thereof as assembled with the tennis balls contained within the tubular sleeve and the handles attached at opposing ends of the sleeve; and

FIGS. 3 and 4 are elevational views thereof showing a shorter version and a longer version of the invention and uses thereof.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

In one aspect of the present invention a massage apparatus is able to apply therapy to a person, and especially to surfaces of the back that are immediately lateral to the spine. Structurally, the invention provides a tubular sleeve 10 of a tufted fabric 12 having a pile 14 on an interior surface, and a pair of spaced apart tennis balls 30 held and engaged in positions within the tubular sleeve 10, the tennis balls 30 each having a fuzzy napped exterior surface 36. A pair of handles 20 are attached by any well known method such as sewing, at opposing ends 16 and 18 of the tubular sleeve 10. The pile 14 of the sleeve 10 and the napped surface 36 of the tennis balls 30 are in mutual engagement and are of such consistency as to hold the tennis balls 30 in selected positions within the tubular sleeve 10. For instance, the balls may be positioned to contact surfaces of the back that are immediately adjacent and lateral to the spine. Any tufted fabric is useful for making the present tubular sleeve and may be swade cloth, velvet or terry cloth. A lose weave terry cloth with a heavy tuft or pile is preferable in that it has the ability to grip the fuzzy outer surface of a tennis ball and also has the ability to stretch so as to better grip the ball. On the other hand, the sleeve 10 should not be made of an elastic cloth such as Lycra because significant tension force is applied to the sleeve 10 during use, and the sleeve 10 must divert this tensile force to the tennis balls to apply massaging action rather then in stretching the fabric.

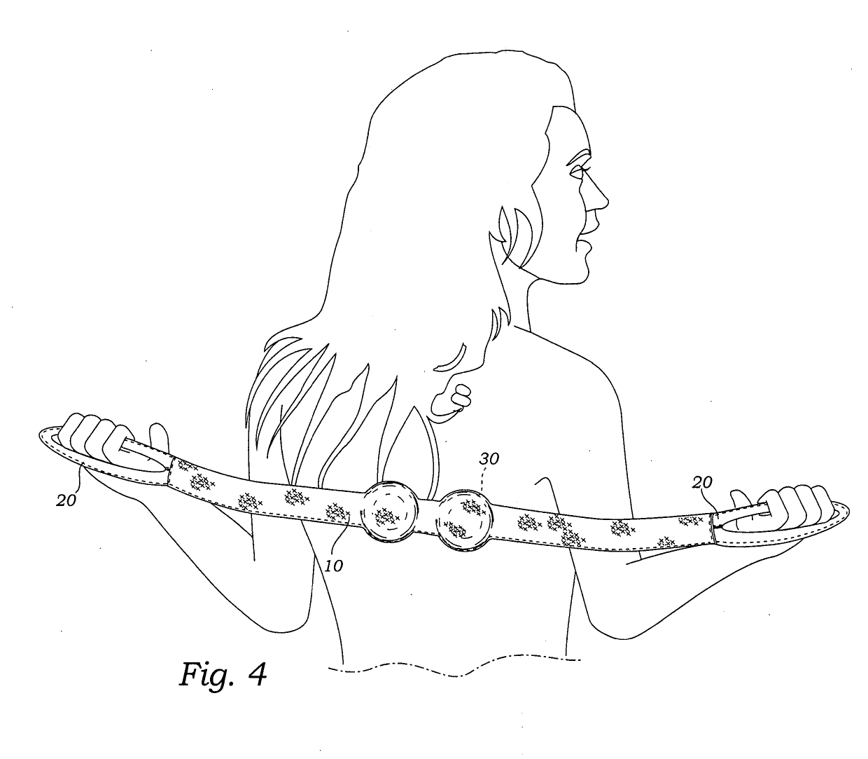

Preferably, the handles are of an elastic material such as rubber so that they are enabled for manual stretching as shown in FIG. 3. This is advantageous in that it provides for moving the hands to a comfortable spaced apart position depending on the size and conformation of one's body. It also provides for a resiliency in applying pressure to the back.

Preferably, in one embodiment of the present invention the tubular sleeve 10 is of such length, typically between 10 and 14 inches, that the handles 20 are able to be positioned just lateral to the person's sides, when the apparatus is positioned horizontally across the small of the back of the person as shown in FIG. 3. In this embodiment, the person is able to apply a significant force to the surface of the small of the back and is also able to move the apparatus over a relatively small vertical range as well, for massage therapy.

Preferably, in an alternate embodiment of the present invention, as shown in FIG. 4, the tubular sleeve is longer; between 36 and 48 inches long, so as to enable a person to comfortably move the apparatus vertically between the neck and the small of the back with the balls 30 positioned lateral to the spine, while pressing the apparatus against the back for massaging over the entire surface of the back.

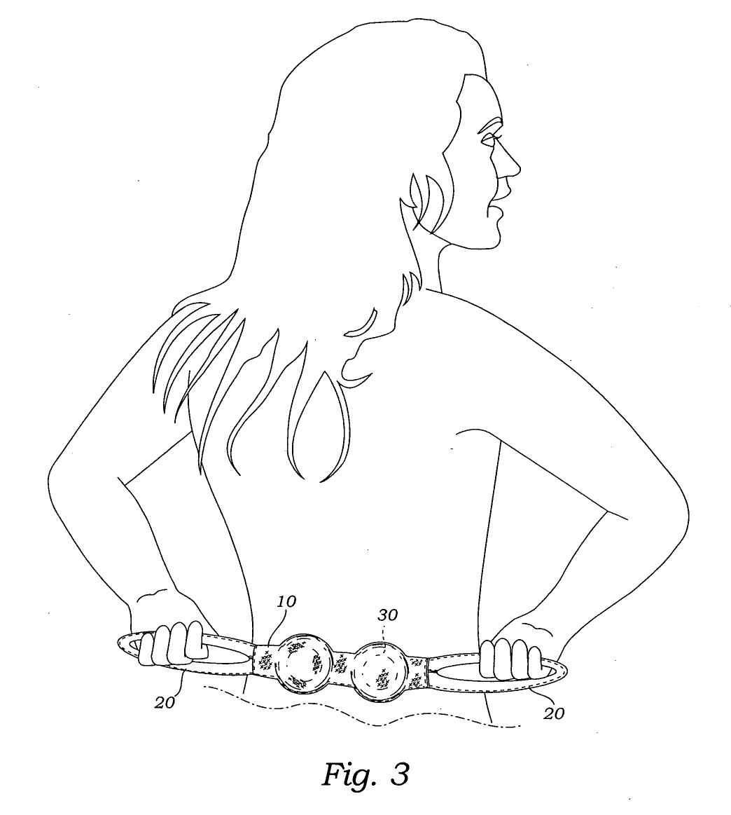

Preferably, the tubular sleeve 10 is of a smaller inside diameter “d” than the outside diameter “D” of the tennis balls 30. Therefore, as shown in FIG. 2A, the fabric of the sleeve 10 is forced to stretch around the balls 30 so that they are captured in selected positions within the sleeve 10. However, they are still free to be moved to alternate selected positions within the sleeve. Also, the tufted fabric 34, 36 of the tubular sleeve 10 and the fuzzy napped surface 12, 14 of the tennis balls 30 are such as to provide a resistance to movement of the tennis balls 30 within the tubular sleeve 10, the resistance being of such magnitude as to prevent migration of the balls 30 within the sleeve 10, yet not so great a resistance as to prevent manual repositioning of the tennis balls 30 without purposeful disengagement of the balls 30 from the fabric of the sleeve 10. This enablement is of particular value and importance in using the invention because it makes the invention extremely inexpensive to manufacture, simple to adjust and use and easy to carry about.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A massage apparatus comprising: a tubular sleeve of a tufted fabric having a pile on an interior surface thereof; a pair of spaced apart tennis balls each with a diameter exceeding a diameter of the tubular sleeve, and positioned within the tubular sleeve, the tennis balls each having a fuzzy napped exterior surface; and a pair of handles attached at opposing ends of the tubular sleeve, the pile of the sleeve and the napped surface of the tennis balls of such substance as to mutually engage in holding the tennis balls in selected engagement positions within the tubular sleeve, yet able to be manually moved to alternate engagement positions within the sleeve, without purposeful disengagement of the balls and the sleeve.

2. The apparatus of claim 1 wherein the handles are of an elastic material enabled for manual stretching.

3. The apparatus of claim 1 wherein the tubular sleeve is of such length as to position the handles at the sides of a person when the apparatus is positioned horizontally across the small of the back of the person.

4. The apparatus of claim 1 wherein the tubular sleeve is of such length as to enable a person to comfortably move the apparatus vertically between the neck of the person and the small of the back of the person, with the apparatus held horizontally using opposing hands of the person while pressing the apparatus against the back of the person.

5. The apparatus of claim 1 wherein the tufted fabric of the tubular sleeve and the fuzzy napped surface of the tennis balls are such as to naturally engage in providing a resistance to movement of the tennis balls within the tubular sleeve, the resistance of such magnitude as to enable manual repositioning of the tennis balls within the sleeve.

6. A massage apparatus comprising: a tubular sleeve of a tufted fabric having a pile on an interior surface thereof; a plurality of tennis balls each with a diameter exceeding a diameter of the tubular sleeve, and positioned within the tubular sleeve, the tennis balls each having a fuzzy napped exterior surface; and a pair of handles attached at opposing ends of the tubular sleeve, the pile of the sleeve and the napped surface of the tennis balls of such substance as to mutually engage in holding the tennis balls in selected engagement positions within the tubular sleeve, yet able to be manually moved to alternate engagement positions within the sleeve without purposeful disengagement of the balls and the sleeve.

7. The apparatus of claim 6 wherein the handles are of an elastic material enabled for manual stretching.

8. The apparatus of claim 6 wherein the tubular sleeve is of such length as to position the handles at the sides of a person when the apparatus is positioned horizontally across the small of the back of the person.

9. The apparatus of claim 6 wherein the tubular sleeve is of such length as to enable a person to comfortably move the apparatus vertically between the neck of the person and the small of the back of the person, with the apparatus held horizontally using opposing hands of the person while pressing the apparatus against the back of the person.

10. The apparatus of claim 6 wherein the tufted fabric of the tubular sleeve and the fuzzy napped surface of the tennis balls are such as to naturally engage in providing a resistance to movement of the tennis balls within the tubular sleeve, the resistance of such magnitude as to enable manual repositioning of the tennis balls within the sleeve.
